(19) United States
(12) Patent Application Publication
(10) Pub. No.: US 2013/0213504 A1
(43) Pub. Date: Aug. 22, 2013

(54) FLUID CONTROL APPARATUS AND FUEL SUPPLY SYSTEM

(71) Applicant: Takeyuki Yabuuchi, Toyota-shi (JP)

(72) Inventor: Takeyuki Yabuuchi, Toyota-shi (JP)

(73) Assignee: TOYOTA JIDOSHA KUBUSHIKI KAISHA, Toyota-shi (JP)

(21) Appl. No.: 13/882,402

(22) PCT Filed: Aug. 24, 2011
(86) PCT No.: PCT/JP2011/004693

§ 371 Date: Apr. 29, 2013

(51) Int. Cl. F02M 37/00

(52) U.S. Cl. CPC F02M 37/0023
USPC 137/565.15; 137/637

(57) ABSTRACT

A fluid control apparatus compact in size and high in performance, and a fuel supply system provided with the fluid control apparatus. The first valve opening direction in which a valve body of a relief valve is separated from a valve seat and the second valve opening direction in which a valve body of a discharge valve is separated from a valve seat are opposite to each other. The first valve opening drive pressure to have the valve body of the relief valve separated from the valve seat and the second valve opening drive pressure to have the valve body of the discharge valve separated from the valve seat are different from each other. The valve seat is provided integrally with the valve body. The fluid control apparatus is provided with a displacement limiting mechanism that limits the displacement of the valve body.

### TECHNICAL FIELD

The present invention relates to a fluid control apparatus and a fuel supply system, and more particularly to a fluid control apparatus having a plurality of valve elements, and a fuel supply system provided with the fluid control apparatus.

### BACKGROUND ART

In recent years, a fuel supply system of an internal combustion engine for a vehicle to pressurize fuel at a high pressure before injecting the fuel into cylinders has been widely used. The fuel supply system of this kind has a pressure pump which is operative to pressurize to a high pressure the fuel fed from a low pressure fuel pump. The pressure pump has a pressure pump mechanism provided with a fluid control apparatus having a plurality of valve elements for checking the fuel from flowing in an opposite direction and for controlling the pressure of the fuel.

As a conventional fluid control apparatus and a conventional fuel supply system as previously mentioned, there have been known a fluid control apparatus and a fuel supply system which are provided with the first and the second valves respectively having check valves connected in parallel with each other to check the fuel from flowing in opposite directions to each other. In the fluid control apparatus and the fuel supply system, the first valve is openably connected with a low pressure pipe passage while the second valve is openably connected with an accumulator that introduces fuel leaked from a high pressure fuel injecting valve side. Opening the first valve causes the pressure level of the accumulator to be maintained at a predetermined pressure level, while opening the second valve causes the fuel in the low pressure pipe passage side to be filled in the accumulator when the pressure level of the accumulator is lowered resulting from repair, fuel shortage and the like (see for example Patent Document 1).

### {Citation List}

### {Patent Literature}

### {Patent Document 1}

Japanese Patent Application Publication No. 2006-504903

### SUMMARY OF INVENTION 23-506

### {Technical Problems}

The conventional fluid control apparatus and the conventional fuel supply system as previously mentioned are, however, constructed to comprises a valve body forming part of a first valve, a second valve seat formed on the valve body of the first valve, a valve body forming part of a second valve, and a second valve spring for always urging the valve body of the second valve in a closing direction. For this reason, the spring load of a first valve spring to resiliently urge the valve body of the first valve in a closing position is required to be set at a degree large enough to overcome the urging force of the second valve spring and to close the first valve.

Therefore, the conventional fuel supply system thus constructed to be employed for a relatively high pressure fluid control, or to be employed for a fluid control of a discharge valve forming part of the conventional fuel supply system for supplying high pressure fuel for example to injectors for injecting the fuel into the cylinders of an internal combustion engine encounters such a problem that not only the size of the first valve spring is increased, thereby making it impossible to produce the fluid control apparatus compact in size, but also the dead volume communicated with a fuel pressure chamber is increased by accommodating the first valve spring, thereby decreasing the efficiency of a pressure pump.

In contrast, it is possible to reduce the spring load to be required for the first and second valve springs for example by reducing the pressure receiving area of the valve body at the valve closing time of the first and second valves. In this construction, the fuel to be discharged with the openings of the first and second valves cannot be promptly discharged. For this reason, there is a problem that when the fluid control apparatus includes a relief valve and the like required to discharge a sufficient discharge amount of fuel, there is caused a delay in the pressure adjustment by the relief valve, thereby leading to lowering the pressure adjustment property.

Moreover, the fuel supply system using the conventional fluid control apparatus as previously mentioned finds it difficult to attain both requirements to secure the relief fluid amount of a pressure control valve for controlling the high pressure fuel and the pressure adjustment property, and to secure pump efficiency by suppressing the valve spring load and the like, thereby making it not easy to ensure both of the fuel supply efficiency and the reliability.

It is, therefore, an object of the present invention to provide a fluid control apparatus which has a compact structure and a high performance and to provide a fuel supply system which is provided with the above fluid control apparatus, thereby making it possible to attain both of fuel supply efficiency and reliability.

### {Solution to Problem}

The fluid control apparatus according to the present invention is made to solve the foregoing problems, and (1) comprises first and second pressure control valves respectively having first and second valve seats respectively forming parts of first and second fluid passages connected in parallel with each other, first and second valve bodies respectively engageable with the first and second valve seats to close the first and second fluid passages, and first and second valve springs for respectively urging the first and second valve bodies in the respective valve closing directions, the fluid control apparatus being operative to have the first valve body moved in a first valve opening direction in which the first valve body is separated from the first valve seat under a first valve opening drive pressure, and to have the second valve body moved in a second opening direction in which the second valve body is separated from the second valve seat under a second valve opening drive pressure, the first and second opening directions being opposite to each other, and the first and second valve opening drive pressures being different from each other, the second valve seat being formed with a member integrally displaced with the first valve body, the fluid control apparatus further comprising a displacement limiting mechanism provided to limit the displacement of the second valve body in the first valve opening direction with respect to the closed position of the second valve body when the first pressure control valve is closed.

By the construction of the fuel supply apparatus as set forth in the above definition (1), the second valve seat displaced integrally with the first valve body in the first valve opening direction can be separated from the second valve body when the first pressure control valve is opened, so that not only the first fluid passage can be opened but also the second fluid passage can be opened in response to the displacement of the first valve body. As a result, even if the pressure receiving area at the valve closing time of the first valve body is relatively small and the urging force and the size of the first valve spring is suppressed, a surplus amount of fuel relieved by the opening of the first pressure control valve can rapidly be discharged through both of the first and second fluid passages. This makes it possible for the fluid control valve according to the present invention to be compact in size and high in performance.

In the fluid control apparatus as set forth in the above definition (1), (2) the second valve seat is preferably integrally provided with the first valve body. This construction makes it possible to reliably move together the first valve body and the second valve seat and to have both of the displacements of the first valve body and the second valve seat equal to each other when the first control valve is opened. As a consequence, the second valve is opened in response to the displacement of the first valve body at the valve opening time of the first pressure control valve, thereby making it possible to obtain a sufficient amount of discharge fluid to be discharged through the first and second pressure valves. Even more, this construction can reduce the number of the parts to be assembled in the fluid control valve, thereby making it possible to produce the fluid control valve compact in size.

In the fluid control apparatus as set forth in the above definition (1) or (2), (3) the displacement limiting mechanism is preferably constituted to include a stoppage member integrally provided with any one of the first valve seat and the second valve body to limit the displacement of the second valve body in the first valve opening direction, and an engagement member to be engaged with the stoppage member to regulate the displacement of the second valve body in the first valve opening direction when the second valve body is displaced by a predetermined amount of displacement in the first valve opening direction from the closed valve position of the second valve body. This construction makes it possible to easily form the engagement member on the second valve body and to easily form the stoppage member on the first valve seat, thereby making it possible to realize a displacement limiting mechanism simple in construction.

In the fluid control apparatus as set forth in the above definition (3), (4) the stoppage member and the engagement member are preferably disposed at the upstream side of the first fluid passage in the valve open state of the first pressure control valve with respect to the first and second valve seats in a fluid passage having the first and second fluid passages connected in parallel with each other. This construction makes it possible to provide the engagement member in the form of a projection radially projecting into the fluid passage from the second valve body, and to provide the stoppage member in the form of a projection projecting into the fluid passage from the member forming the first valve seat, thereby making it possible to prevent the fluid control valve from being enlarged in size as compared with the control valve without such an engagement member and a stoppage member.

In the fluid control apparatus as set forth in the above definition (3), (5) the stoppage member and the engagement member are preferably disposed at the downstream side of the first fluid passage in the valve open state of the first pressure control valve with respect to the first and second valve seats in a fluid passage having the first and second fluid passages connected in parallel with each other. In this case, the construction of the stoppage member disposed in the first fluid passage makes it possible to use the part of the second valve body as an engagement member, thereby making it possible to simplify the shapes of the parts and reduce the number of the parts to be assembled in the fluid control valve.

In the fluid control apparatus as set forth in any one of the above definitions (1) to (5), (6) the first valve body preferably has a first seal surface to be contacted with the first valve seat at the valve closing time of the first valve body, the first valve body being displaceable integrally with a member having an annular second seal surface flush with the first seal surface and the radially inward of the first seal surface to be contacted with the second valve body. In this case, the construction makes it possible to concurrently and easily process the first seal surface and the second seat surface, thereby making it possible to reduce the production cost of the fluid control valve.

In the fluid control apparatus as set forth in any one of the above definitions (1) to (5), (7) the first valve body has a first seal surface to be contacted with the first valve seat at the valve closing time of the first valve body, the first valve body being displaceable integrally with a member constituted by a cylindrical body having an annular second seal surface positioned to be displaced from the first seal surface in the first valve opening direction and the radially inward of the first seal surface to be contacted with the second valve body, the second valve body being accommodated in the member displaceable integrally with the first valve body. In this case, the construction has the member displaceable integrally with the first valve body in a cylindrical shape, and makes it possible to provide a fluid passage having a sufficiently large cross-sectional area in the inner portion of the cylindrical member at the side opposite to the second valve seat with respect to the second valve body, so that the passage cross-sectional area of the first fluid passage to discharge the surplus amount of fuel at the valve opening time of the first pressure control valve can sufficiently be secured.

A fuel supply system provided with the fluid control apparatus as set forth in any one of the above definitions (1) to (7), (8) comprises a pump body formed with a fuel introduction port and a fuel discharge port, and formed with a low pressure side fuel passage held in communication with the fuel introduction passage and a high pressure side fuel passage held in communication with the fuel discharge port, a pressure pump mechanism having a fuel pressure chamber formed between the low pressure side fuel passage and the high pressure side fuel passage in the pump body, and a pressuring member driven to pressurize the fuel in the fuel pressure chamber, a plurality of valve elements including a suction valve opened to allow the fuel to be sucked into the fuel pressure chamber from the low pressure side fuel passage, and a discharge valve opened to allow the fuel to be discharged to the high pressure side fuel passage from the fuel pressure chamber, and the second pressure control valve constituting the discharge valve, and the first pressure control valve constituting the relief valve having a valve opening direction opposite to that of the discharge valve, and an opening set pressure larger than that of the discharge valve.

As a result, even if the pressure receiving area at the valve closing time of the first valve body of the fluid control apparatus is relatively small and the urging force and the size of the first valve spring is made small, a surplus amount of fuel relieved by the opening of the first pressure control valve can rapidly be discharged through both of the first and second fluid passages. It will be therefore be understood that even if the discharge pressure of the pressure pump mechanism is heightened or otherwise the discharge fluid amount is increased, the fluid control apparatus according to the present invention can appropriately relieve a necessary amount of high pressure fuel when the high pressure fuel reaches the limit pressure of the allowable pressure range. The present invention therefore can provide a fuel supply system which is high in efficiency and excellent in reliability by obtaining both of the merits of securing the efficiency of the pressure pump mechanism and of securing the necessary relief fluid amount.

### Advantageous Effects of Invention

The fluid control valve according to the present invention is provided with a displacement limiting mechanism for limiting the displacement of the second valve body in the first valve opening direction with respect to the second valve seat integrally displaced with the first valve body, thereby making it possible to separate the second valve body from the second valve seat when the first valve body is opened to be separated from the first valve seat. This means that at the valve opening time of the first control valve, not only the first fluid passage but also the second fluid passage can be opened in response to the displacement of the first valve control valve, thereby making it possible to rapidly discharge the fuel to be relieved in response to the opening of the first valve control valve through both of the first and second fluid passages even if the pressure receiving area at the valve closing time of the first valve body of the fluid control apparatus is relatively small and the urging force of the first valve spring is made small. The present invention can provide a fluid control apparatus which is compact in size and high in performance. Also, the present invention can provide a fuel supply apparatus which is provided with the fluid control apparatus previously mentioned, and thus is high in efficiency and excellent in reliability by obtaining both of the merits of improving the efficiency of the pressure pump mechanism and of securing the necessary relief fluid amount.

### BRIEF DESCRIPTION OF DRAWINGS

FIG. 1 is a cross-sectional view showing a schematic construction of a fluid control apparatus according to a first embodiment of the present invention.

FIG. 2 is a cross-sectional view taken along the line II-II of FIG. 1.

FIG. 3 is a schematic construction view of a fuel supply system according to the first embodiment of the present invention.

FIG. 4 is a cross-sectional view showing the schematic construction of the fluid control apparatus according to the first embodiment of the present invention for explanation of the behavior of a discharge valve when the discharge valve is opened.

FIG. 5 is a cross-sectional view showing the schematic construction of the fluid control apparatus according to the first embodiment of the present invention for explanation of the behavior of a relief valve when the relief valve is opened.

FIG. 6 is a timing chart that explains the operation of the fuel supply system according to the first embodiment of the present invention.

FIG. 7 is a cross-sectional view showing a schematic construction of a fluid control apparatus according to a second embodiment of the present invention.

FIG. 8 is a cross-sectional view showing the schematic construction of the fluid control apparatus according to the second embodiment of the present invention for explanation of the behavior of a relief valve when the relief valve is opened.

FIG. 9 is a cross-sectional view showing a schematic construction of a fluid control apparatus according to a third embodiment of the present invention.

FIG. 10 is a cross-sectional view showing the schematic construction of the fluid control apparatus according to the third embodiment of the present invention for explanation of the behavior of a relief valve when the relief valve is opened.

FIG. 11 is a cross-sectional view showing a schematic construction of a fluid control apparatus according to a fourth embodiment of the present invention.

FIG. 12 is a cross-sectional view showing a schematic construction of a fluid control apparatus according to a fifth embodiment of the present invention.

### DESCRIPTION OF EMBODIMENTS

The preferred embodiments of the present embodiments will be described hereinafter with reference to the accompanying drawings.

### First Embodiment

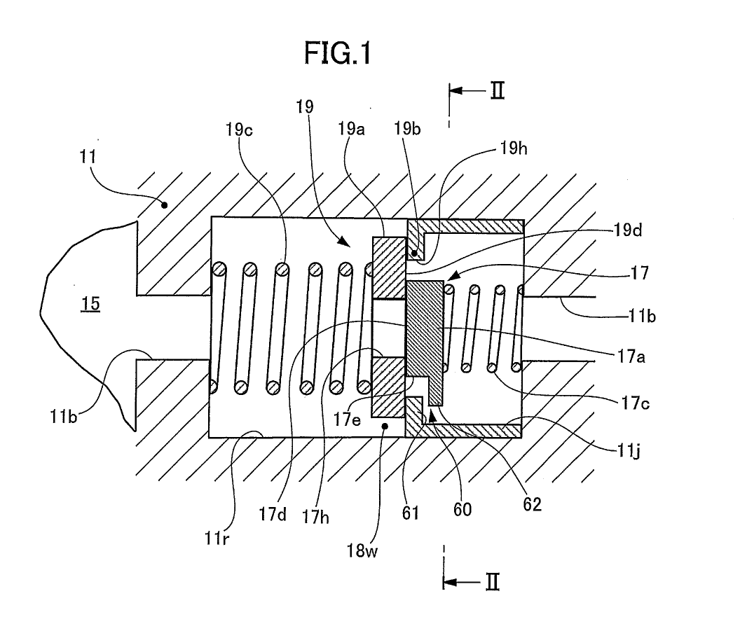

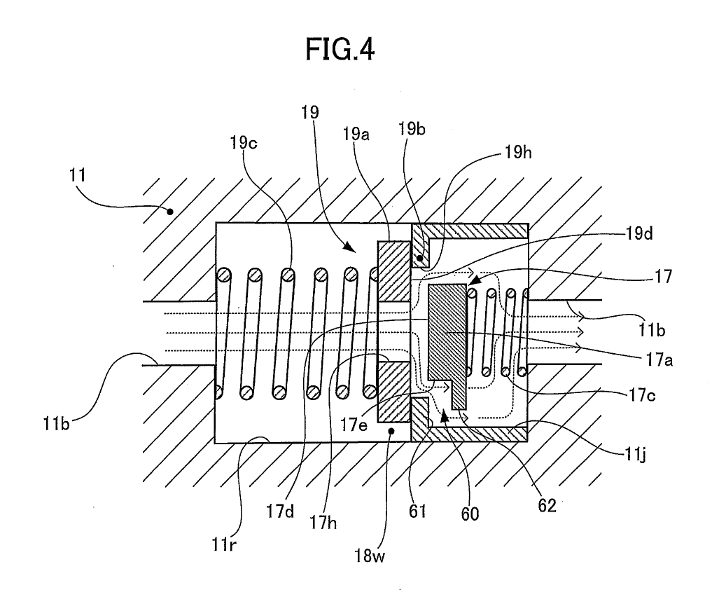

FIGS. 1 to 6 are each a schematic construction view showing a fluid control apparatus according to a first embodiment of the present invention, and a fuel supply system provided with the above fluid control apparatus.

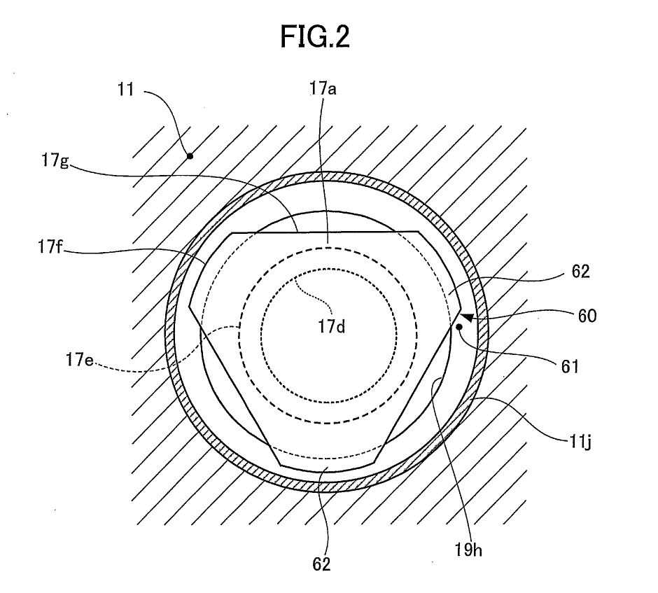

As schematically shown in FIGS. 1 and 2, the fuel supply system 1 according to the present embodiment is provided in an internal combustion engine mounted on a vehicle, such as for example a multi-cylinder gasoline engine (hereinafter simply referred to as an engine) 2 including a cylinder injection type and a dual injection type. The fuel supply system 1 is provided with a plunger pump type fuel supply apparatus 10 which is operative to pressurize the fuel to a high pressure and to discharge the high pressure fuel to the engine 2.

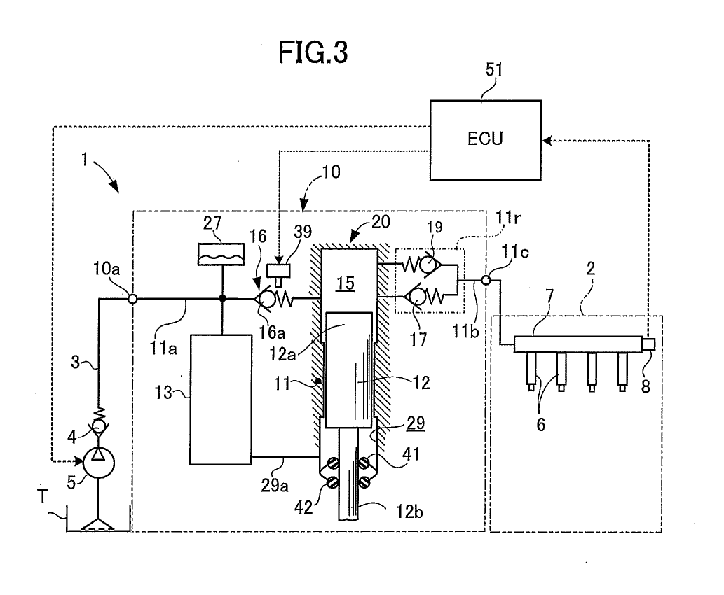

The fuel supply apparatus 10 is shown in FIG. 3 as being connected with a low pressure fuel pump 5 constituting a feed pump through a pipe 3 and a check valve 4, so that the fuel supply apparatus 10 is adapted to allow fuel pressurized at a relatively low feed pressure to be introduced therein from the low pressure fuel pump 5. The low pressure fuel pump 5 is provided in a fuel tank T mounted on the vehicle, and thus can pump up fuel such as for example gasoline stored in the fuel tank T.

The low pressure fuel pump 5 is constituted for example by a Wesco-type motorized pump having a pump impeller, and a drive motor that rotationally drives the pump impeller not shown. The Wesco-type motorized pump is operated in such a manner that the rotational speed is varied in response to the load torque with the same input (for example corresponding to the product of the terminal voltage and the load current), or the rotational speed of the drive motor is varied by the input change with the same load, thereby making it possible to vary the discharge pressure and the discharge amount per unit of time. The check valve 4 constitutes a low pressure discharge valve operative to prevent the fuel discharged from the low pressure fuel pump 5 from flowing back into the low pressure fuel pump 5.

Although not shown in detail, the engine 2 has a plurality of injectors 6 (fuel injection valves) that inject the fuel into a plurality of cylinders. The injectors 6 are connected with a delivery pipe 7 which is capable of storing the pressure fuel. The fuel supply apparatus 10 is adapted to pressurize and supply the high pressure fuel to the delivery pipe 7.

The delivery pipe 7 is adapted to store the high pressure fuel discharged from the fuel supply apparatus 10 and accumulate the pressure, and to deliver and supply the high pressure fuel to the injectors 6 for cylinder injection provided with the respective cylinders (not shown) of the engine 2 when the injectors 6 are opened.

As shown in FIG. 3, the fuel supply apparatus 10 has a pump body 11, and a substantially cylindrical plunger 12 (pressure member) provided therein and axially reciprocable with respect to the pump body 11. The pump body 11 is formed with a suction passage 11a (low pressure side fuel passage) for sucking the fuel from the low pressure fuel pump 5 in the pump body 11, and a discharge passage 11b (high pressure side fuel passage) for discharging the fuel pressurized in the pump body 11 to the delivery pipe 7. The pump body 11 has a fuel introduction port 10a positioned at the upstream end side of the suction passage 11a.

The plunger 12 has an inner end portion 12a (upper side end portion in FIG. 3) slidably received in the pump body 11. The pump body 11 is formed therein between the plunger 12 and the pump body 11 with a fuel pressure chamber 15 which is held in communication with the suction passage 11a and the discharge passage 11b. The pressure chamber 15 has a volume variable, i.e., increased or decreased, in response to the reciprocal displacement of the plunger 12 to enable the fuel to be sucked into the pressure chamber 15 or discharged from the pressure chamber 15.

The suction passage 11a of the pump body 11 has a portion formed with a suction gallery 13 (fuel storing chamber) having a predetermined volume large enough to store the fuel from the low pressure fuel pump 5, so that the fuel introduced into the suction passage 11 a can temporarily be stored in the suction gallery 13.

The suction gallery 13 is held in communication with an auxiliary chamber 29 formed by the outer end portion 12b of the plunger 12 and the pump body 11 through an inner communication passage 29a, so that the fuel is allowed to be moved between the suction gallery 13 and the auxiliary chamber 29 (internal chamber) as the plunger 12 is reciprocally displaced. Here, the auxiliary chamber 29 is partitioned from the fuel pressure chamber 15 by the plunger 12 serving as a pressure member to form an internal chamber of the pump body 11 and hermetically sealed from the space outside of the pump body 11 by seal members 41, 42.

The plunger 12 is engaged at its outer end portion 12b with a drive cam not shown to drive the plunger 12. The drive cam is known in the art and has a cam profile with at least one circumferential portion larger in radius than radii of the other circumferential portions (for example a cam profile in an egg shape, an oval shape or a polygonal shape with corners rounded). The drive cam is adapted to be rotationally driven by the power of the engine 2, but may be rotationally driven by an electric motor.

In the vicinity of the outer end portion 12b of plunger 12 is provided a spring seat not shown. Between the spring seat and the pump body 11 is disposed a compression coil spring to resiliently urge the outer end portion 12b of plunger 12 toward the drive cam. This means that when the drive cam is rotationally driven by the power of the engine 2 (or electric power), plunger 12 can be reciprocally driven in response to the rotation of the drive cam. The outer end portion 12b of plunger 12 is of course provided with a cam follower roller and the like held in engagement with the drive cam.

At the forward and the backward of the fuel pressure chamber 15, viz., the suction side and the discharge side of the fuel pressure chamber 15 are provided a plurality of valve elements constituted by a suction valve 16 and a discharge valve 17. An additional one of the plurality of valve elements is also constituted by a relief valve 19 which will become apparent as the description proceeds.

Here, the suction valve 16 serves to allow the fuel to be sucked into the fuel pressure chamber 15 at the downstream side of the suction gallery 13, and to fulfill a check valve function to prevent the fuel from flowing back. The suction valve 16 is operative to be opened when the pressure of the fuel in the fuel pressure chamber 15 is decreased by a predetermined suction valve opening difference pressure (for example several tens kPa of difference pressure) with respect to the pressure of the fuel in the suction gallery 13. In other words, the downward displacement (see FIG. 3) of plunger 12 to increase the volume of the fuel pressure chamber 15 causes the fuel in the fuel pressure chamber 15 to be reduced in pressure, thereby making it possible for the suction valve 16 to be opened in the closed valve state of the discharge valve 17.

More specifically, the suction valve 16 serves as a check valve which is operative to be opened when the suction valve opening difference pressure at the front and rear sides of the suction valve 16 occurs, and operative to be urged toward an opening position by an electromagnetic operation unit 39. The electromagnetic operation unit 39 is constructed to accommodate therein a plunger to be engaged with a valve body 16a forming part of the suction valve 16, and a compression coil spring to normally resiliently urge the plunger in the opening direction of the valve body 16a. The electromagnetic operation unit 39 is operative to be energized only in the period of the request of the fuel discharge to the delivery pipe 7 to have the plunger retracted against the urging force of the compression coil spring. This means that the electromagnetic operation unit 39 is operative to have the valve body 16a of the suction valve 16 serve as a check valve to be in an operable state only in the period of the request of the fuel discharge from the fuel pressure chamber 15. The suction valve 16 and the electromagnetic operation unit 39 constitute in combination an electromagnetic spill valve of the normally open type.

The discharge valve 17 is constituted by a check valve to allow the fuel to be discharged from the fuel pressure chamber 15, and to fulfill a check valve function to prevent the fuel from flowing back toward the fuel pressure chamber 15.

The discharge valve 17 is operative to be opened when the pressure of the fuel in the fuel pressure chamber 15 is increased by a predetermined discharge valve opening difference pressure (substantially equal to the suction valve opening difference pressure, for example, several tens kPa of difference pressure) with respect to the pressure (delivery pressure) of the fuel at the downstream side of the discharge valve 17. In other words, the upward displacement (see FIG. 3) of plunger 12 to decrease the volume of the fuel pressure chamber 15 causes the fuel in the fuel pressure chamber 15 to be pressurized, viz., increased in pressure, thereby generating the discharge valve opening difference pressure at the front and rear sides of the discharge valve 17, and thus making it possible for the discharge valve 17 to be opened in the closed valve state of the suction valve 16.

The pump body 11, the plunger 12, the fuel pressure chamber 15, the suction valve 16, the discharge valve 17, and the drive cam as previously mentioned constitute as a whole a pressure pump mechanism 20. The pressure pump mechanism 20 is constructed to form a fuel pressure chamber 15 between the suction passage 11 a and the discharge passage 11b in the pump body 11, and to have the plunger 12 to be driven to pressurize the fuel in the fuel pressure chamber 15.

At the discharge side of the fuel pressure chamber 15 in the pump body 11 is formed a bypass passage 18w bypassing the discharge valve 17 (second pressure control valve) and having a relief valve 19 (first pressure control valve) provided thereon to selectively open or close the bypass passage 18w.

The relief valve 19 is operative to be opened when the pressure of the fuel in the discharge passage 11b at the downstream side of the discharge valve 17 is increased by a predetermined relief valve opening difference pressure (for example difference pressure larger by several MPa than the maximum discharge pressure) with respect to the pressure of the fuel in the fuel pressure chamber 15. The above predetermined relief valve opening difference pressure is sufficiently larger than the predetermined discharge valve opening difference pressure. The expression “sufficiently larger than the predetermined discharge valve opening difference pressure” is intended to mean sufficiently large to the degree that the relief valve is not opened with the pulsation degree of the fuel pressure in the delivery pipe 7. The above predetermined relief valve opening difference pressure is set within the range bearable with the limit pressure of the piping of the parts following the delivery pipe 7. The discharge valve 17 and the relief valve 19 has a construction as will be stated hereinafter and constitutes a fluid control apparatus as defined in the present invention.

As shown in FIGS. 1, 2 and 4, the discharge passage 11b of the pump body 11 has an intermediate portion having an expanded passage portion 11r expanded with the cross-sectional area larger than those of the passage portions at the front and rear sides of the expanded passage portion 11r. The expanded passage portion 11r has the discharge valve 17 and the relief valve 19 accommodated therein.

The discharge valve 17 is constituted by a valve body 17a (second valve body) in the form of a plate and capable of selectively opening or closing the discharge passage 11b in the closed valve state of the relief valve 19, an annular valve seat 17b (second valve seat) allowing the valve body 17a to be selectively engaged (seated) with or disengaged, and a compression coil spring 17c (second valve spring) that urges the valve body 17a in the closing direction having the valve body 17a seated on the valve seat 17b.

The valve body 17a of the discharge valve 17 (hereinafter simply referred to as a discharge valve body) is shown in FIG. 2 to be in the form of a roughly triangular shape with the plate-shaped outer peripheral portion equi-angularly and equi-spacedly cut off The discharge valve body 17a has a plurality of first outer peripheral surfaces 17f positioned on the same circumferential surface of the discharge valve body 17a, and a plurality of second peripheral surfaces 17g each positioned at the radially inner side than the circumferential surface of the first outer peripheral surfaces 17f.

The valve seat 17b of the discharge valve 17 (hereinafter simply referred to as a discharge valve seat) has a valve bore 17h (second fluid passage) inwardly forming part of the discharge passage. The discharge valve seat 17b is integrally formed with the central portion of the valve body 19a of the relief valve 19 which will become apparent as the description proceeds. The valve bore 17h of the discharge valve 17 (hereinafter simply referred to as a discharge valve bore) is formed to penetrate the central portion of the valve body 19a. The discharge valve body 17a has a valve seal surface 17d capable of closing the one end of the discharge valve bore 17h when the discharge valve body 17a is seated on the annular discharge valve seat 17b.

The valve spring 17c of the discharge valve 17 (hereinafter simply referred to as a discharge valve spring) has a spring load set to have the discharge valve body 17a held in engagement with the discharge valve seat 17b for maintaining the closed valve state of the discharge valve 17 until the discharge pressure from the fuel pressure chamber 15 reaches a predetermined discharge pressure (pressure higher than the pressure of the fuel in the delivery pipe 7 by a predetermined discharge valve opening pressure difference). When the discharge pressure from the fuel pressure chamber 15 becomes no less than the predetermined discharge pressure, the valve body 17a is separated from the valve seat 17b to open the discharge valve 17, so that the high pressure fuel is supplied to the delivery pipe 7 from the fuel pressure chamber 15 of the pressure pump mechanism 20.

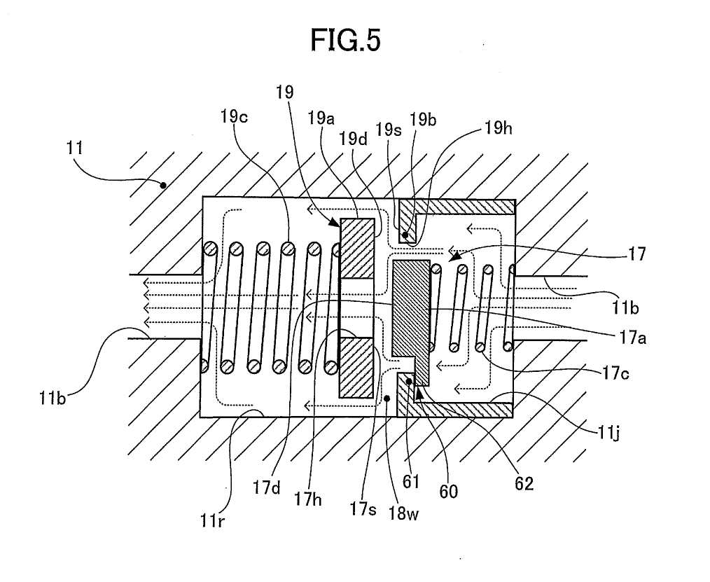

As shown in FIG. 1 and FIG. 5, the relief valve 19 is constituted by a plate-shaped valve body 19a (first valve body), an annular valve seat 19b (first valve seat) capable of having the valve body 19a selectively engaged (seated) with or separated from the valve seat 19b, and a valve spring 19c (first valve spring) constituted by a compression coil spring to resiliently urge the valve body 19a in the direction to be seated on the valve seat 19b.

The valve body 19a of the relief valve 19 (hereinafter simply referred to as a relief valve body) is in the form of a roughly disc shape larger in diameter than the discharge valve body 17a, and has a central portion formed with the previously mentioned discharge valve bore 17h forming part of the discharge passage 11b. The discharge valve 17 functions as a check valve to be maintained in the normally closed valve state when there is generated a pressure difference large enough to the degree of opening the relief valve 19. This means that the relief valve body 19a constitutes integrally with the discharge valve body 17a a relief valve body as a part of the relief valve 19.

The relief valve body 19a is shaped to form a bypass passage 18w passing through the outer peripheral side of the relief valve body 19a in the pump body 11 to bypass the discharge valve bore 17h. The bypass passage 18w is communicated with the discharge passage 11b in parallel with the discharge valve bore 17h.

The relief valve body 19a is, as shown in FIG. 1, operative to close the bypass passage 18w while the central discharge valve bore 17h forms part of the discharge passage 11b when the relief valve body 19a is seated on the relief valve seat 19b, and is, as shown in FIG. 5, operative to open the bypass passage 18w when the relief valve body 19a is separated from the relief valve seat 19b.

The valve seat 19b of the relief valve 19 (hereinafter simply referred to as a relief valve seat) is formed therein with a valve bore 19h (first fluid passage) forming part of the discharge passage 11b. The relief valve seat 19b has a flat and annular seat surface 19s (first seat surface) at the one end (left end in FIG. 1) side of the valve bore 19h to be contacted with the relief valve body 19a. The relief valve body 19a has a valve seal surface 19d (first seal surface) in the form of a roughly circular shape and capable of closing the one end of the valve bore 19h when the relief valve body 19a is contacted with the seat surface 19s of the relief valve seat 19b. The discharge valve 17 has an annular seat surface 17s (second seat surface) to be in contact with the valve seal surface 17d of the discharge valve body 17a at the valve body central portion (member integrally displaced with the valve body 19a) positioned radially inwardly of the valve seal surface 19d and flush with the valve seal surface 19d of the relief valve 19.

The above relief valve 19 is operative to take the closed valve state maintained with the relief valve body 19a engaged with the relief valve seat 19b by the valve spring 19c until the pressure of the fuel in the discharge passage 11b is increased (additionally the pressure of the fuel in the fuel pressure chamber 15 is decreased) to have the pressure difference at the front and rear sides of the relief valve body 19a reach the predetermined relief valve opening pressure difference.

The discharge valve 17 and the relief valve 19 constitute in combination first and second pressure control valves, respectively, as defined in the present invention. As will be understood from the foregoing description, the valve seats 17b, 19b of the discharge valve 17 and the relief valve 19 form the discharge valve bore 17h and the bypass passage 18w (relief valve bore 19h inclusive) which respectively constitute first and second fluid passages connected in parallel with each other. The valve bodies 17a, 19a of the discharge valve 17 and the relief valve 19 are respectively engaged with the valve seats 17b, 19b of the discharge valve 17 and the relief valve 19 to enable the discharge valve bore 17h and the bypass passage 18w to be closed.

The discharge valve 17 and the relief valve 19 are arranged in opposite directions to each other so that the first valve opening direction and the second valve opening direction become in opposite directions to each other. The relief valve body 19a is separated from the relief valve seat 19b in the first valve opening direction, and the suction valve body 17a is separated from the suction valve seat 17b in the second valve opening direction.

The discharge valve seat 17b is integrally formed with a member integrally displaced with the relief valve body 19a, for example, the relief valve body 19a itself. The relief valve opening difference pressure (first valve opening drive pressure from the downstream side) to have the relief valve body 19a separated from the relief valve seat 19b is different from the discharge valve opening difference pressure (second valve opening drive pressure from the side of the fuel pressure chamber 15) to have the discharge valve body 17a separated from the discharge valve seat 17b.

On the other hand, the fluid control apparatus according to the present embodiment further comprises a displacement limiting mechanism 60 provided to limit the displacement of the discharge valve body 17a in the first valve opening direction (leftward direction in FIG. 1 and FIG. 5) within a preliminarily set movement range with respect to the closed position (position shown in FIG. 1) of the discharge valve body 17a when the relief valve 19 is closed.

The displacement limiting mechanism 60 is constituted to include an annular stoppage member 61 integrally formed with the relief seat 19b limiting the displacement of the discharge valve body 17a in the first valve opening direction, and an engagement member 62 to be engaged with the stoppage member 61 limiting the displacement of the discharge valve body 17a in the first valve opening direction when the discharge valve body 17a is displaced by a predetermined amount of displacement in the first valve opening direction from the closed position of the discharge valve body 17a while the relief valve 19 is in the closed valve state. The predetermined amount of displacement herein stated is intended to mean for example a displacement amount larger than the tolerable assembling errors and the dimensional errors of the stoppage member 61 and the engagement member 62, and is set to engage the stoppage member 61 with the engagement member 61 only when the relief valve 19 is opened without fail. In addition, the predetermined amount of displacement is set in response to the relief flow amount, the passage cross-sectional area and other items requested in design.

The engagement member 62 is constituted by a plurality of lobes, for example, three lobes integrally formed with the discharge valve body 17a to equi-angularly and radially project at the other surface side of the discharge valve body 17a with respect to a circular plate form portion 17e of the one surface side of the discharge valve body 17a formed with a valve seat surface 17d. The engagement member 62 with the lobes thus formed is as a whole in the form of a roughly triangular flange shape at the rear surface side of the discharge valve body 17a (opposite surface side to the valve seat surface 17d).

In the present embodiment, the stoppage member 61 and the engagement member 62 are disposed in the discharge passage 11b connected with the discharge valve bore 17h and the bypass passage 18w at the upstream side of the bypass passage 18w (downstream side in the discharge direction through the discharge valve 17) in the open valve state of the relief valve 19 with respect to the relief valve seat 19b and the discharge valve seat 17b (especially the seal position of the relief valve 19 in the closed valve state).

The shape of engagement member 62 with the plurality of lobes may be changed into another shape different from the shape shown in the drawings for the purpose of enlarging the opening area of the plurality of opening portions A (see FIG. 2) positioned radially outwardly of the discharge valve body 17a in the valve bore 19h of the relief valve 19. For example, the engagement member 62 can be formed with projection portions respectively having substantially the same widths at the positions given in the radiation direction (radial direction) of the discharge valve body 17a. In this case, the plurality of opening portions A are each in the form of a roughly fan-shaped window with the predetermined angle.

The electromagnetic operation unit 39 is controlled by an ECU 51 for energization when the engine 2 is operated to drive the drive cam of the fuel supply apparatus 10 and to reciprocate the plunger 12 with its lift amount periodically fluctuated.

The ECU 51 is provided with CPU (Central Procession Unit), ROM (Read Only Memory), RAM (Random Access Memory), and a backup memory such as nonvolatile memory and the like. In addition, the ECU 51 is constituted to include an input interface circuit and an output interface circuit. The ECU 51 is adapted to be inputted with an ON/OFF signal from an ignition switch not shown, and to be fed with power from a battery also not shown. The input interface circuit of the ECU 51 is connected with various kinds of sensors, and thus the ECU 51 is adapted to be inputted with the information from the sensors through the interface circuit including an A/D converter and the like. The output interface circuit of the ECU 51 is connected with a switching circuit and a drive circuit for controlling actuators such as injectors 6, a low pressure fuel pump 5 and the like.

The ECU 51 is adapted to execute a control program stored in the ROM, thereby making it possible to execute an electronic throttle control, a fuel injection amount control, an ignition timing control, a fuel cut control and the like which are all known in the art. For example, the ECU is operative to calculate a basic injection amount required for every combustion in accordance with an intake air amount detected by an airflow meter and the number of engine revolutions detected by a crank angle sensor, to calculate the fuel injection amount by performing various kinds of corrections in response to the operating state of the engine 2 and by performing air-fuel ratio feedback correction and other corrections, and to drive the opening operations of the injectors 6 in response to the fuel injection time in accordance with the fuel injection amount thus calculated.

In the present embodiment, the ECU 51 is further operative to repeatedly determine at regular intervals whether the actual pressure of the fuel in the delivery pipe 7 reaches or does not reach a preliminarily set delivery pressure. When the fuel injections are performed by the injectors 6, and thereby the actual pressure of the fuel in the delivery pipe 7 comes to be lower than the preliminarily set delivery pressure, the ECU 51 is operative to energize the electromagnetic operation unit 39 during a period in which the lift amount of the plunger 12 is increased to have the detected value from the fuel pressure sensor 8 reach a set value (a predetermined crank angle period in which the fuel can be pressurized), and thereby to pressurize and supply the high pressure fuel into the delivery pipe 7 from the fuel pressure chamber 15.

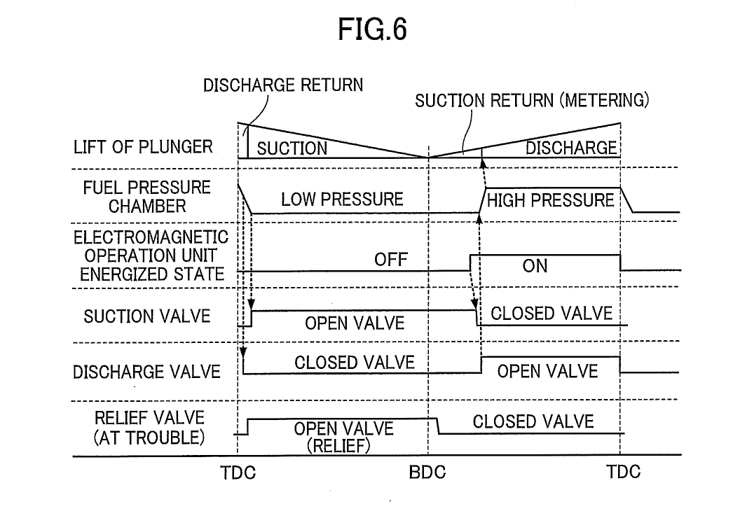

When the lift amount of the plunger 12 is decreased, and the volume of the fuel pressure chamber 15 is increased as shown in FIG. 6, the discharge valve 17 having the fuel pressure in the delivery pipe 7 side kept high is maintained in the closed valve state, while the suction valve 16 is maintained in the opened valve state with the electromagnetic operation unit 39 held under deenergization. At this time, the fuel is therefore suctioned into the fuel pressure chamber 15. When the lift amount of plunger 12 is increased, and the volume of the fuel pressure chamber 15 is reduced, the electromagnetic operation unit 39 is energized. At this time, the suction valve 16 is closed to pressurize the fuel in the fuel pressure chamber 15. Therefore, the pressure of the fuel in the fuel pressure chamber 15 is at this time increased to open the discharge valve 17. The pressure level of the fuel discharged from the fuel pressure chamber 15 is for example about 4 to 20 MPa. In the event that the pressure of the fuel downstream of the discharge valve 17 is extremely raised by something abnormal, the lift amount of plunger 12 is reduced, and the volume of the fuel pressure chamber 15 is increased. At this time, the relief valve 19 is adapted to be opened to prevent the pressure of the fuel in the delivery pipe 7 from being extremely raised. In other words, the relief valve 19 is adapted to be opened when the pressure of the fuel in the delivery pipe 7 side reaches an excessive fuel pressure level exceeding the fuel pressure level caused by the fuel pressure in the delivery pipe 7 normally pressurized. The symbols “TDC” and “BDC” appearing in FIG. 6 respectively indicate upper and lower dead positions (maximum and minimum lift positions) of the plunger 12.

In the period excluding the closed valve period of the suction valve 16, the electromagnetic operation unit 39 is deenegized by the ECU 51 (energization OFF state in FIG. 6) to have the urging force of the compression coil spring act on the plunger of the electromagnetic operation unit 39 in the opening direction of the suction valve 16, thereby opening the suction valve 16.

The operation of the fluid control apparatus according to the present embodiment will be explained hereinafter.

In the fuel supply system of the present embodiment constructed as previously mentioned, the injectors 6 is operated to be open to execute the fuel injection in the engine 2 when the engine 2 is operated. On the other hand, the suction valve 16 is operated to be closed to supply the high pressure fuel to the delivery pipe 7 in the period of the lift amount of plunger 12 being increased to maintain the pressure of the fuel in the delivery pipe 7 detected by the fuel pressure sensor 8 to the set delivery pressure.

When the relief valve 19 is opened in this state as shown in FIG. 5, the discharge valve seat 17b is displaced integrally with the relief valve body 19a in the first valve opening direction (leftward in FIG. 5). When, on the other hand, the displacement amount of the discharge valve body 17a in the first valve opening direction from the valve closing position of the discharge valve body 17a (the stopped position of the discharge valve body 17a under the valve closing state of the relief valve 19) reaches the limit value of the displacement range preliminarily set, the engagement member 62 integral with the discharge valve body 17a is engaged with the stoppage member 61 at the side of the pump body 11, thereby restricting the discharge valve body 17a to be further displaced in the first valve opening direction. This leads to the fact that the discharge valve seat 17b is separated from the discharge valve body 17a.

At this time, not only the bypass passage 18w can be opened, but also the discharge valve bore 17h can be opened in response to the displacement of the relief valve 19a. Even if the pressure receiving area is decreased to some extent, and the urging force of the valve spring 19c is also decreased to some extent at the valve closing time of the relief valve body 19a of the relief valve 19 having a high relief set pressure, a surplus amount of fuel to be relieved by the opening of the relief valve 19 can rapidly be relieved through both of the bypass passage 18w and the discharge valve bore 17h. The cross-sectional area of the valve bore 17h of the discharge valve 17 and the pressure receiving area at the valve closing time of the discharge valve body 17a are not needed to be restricted to respective small areas.

As a result, the discharge valve 17 having a high discharge pressure and the relief valve 19 having a relatively high relief set pressure can be accommodated in the expanded passage portion 11r of the discharge passage 11b in the form of a single unit, thereby making it possible to provide a fluid control apparatus which is compact in construction and of a high performance.

Moreover, the volume of the relief passage portion positioned at the side of the fuel pressure chamber 15 from the relief valve 19 in the expanded passage portion 11r of the discharge passage 11b is not needed to be expanded, thereby not leading to the decrease of the pump efficiency of the pressure pump mechanism 20.

Further, the present invention is constructed to have the discharge valve seat 17b integrally formed with the relief valve body 19a, so that the displacement of the relief valve body 19a and the displacement of the valve seat 17b can reliably be carried out together at the valve opening time of the relief valve 19 to enable the displacement amounts of the relief valve body 19a and the valve seat 17b to be equal to each other. Therefore, at the time of the valve opening time of the relief valve 19, it is possible to obtain a sufficient relief flow amount in response to the displacement amount of the relief valve body 19a. Moreover, exclusive parts are unnecessary for displacing the discharge valve seat 17b, thereby making it possible to reduce the number of parts and to make the apparatus compact in construction.

Further, the engagement member 62 and the stoppage member 61 can easily be integrally formed on the discharge valve body 17a and on the pump body 11 serving as a member to from the relief valve seat 19b, respectively, thereby making it possible to realize the simple displacement limiting mechanism 60.

In addition, the present embodiment is constructed to have the stoppage member 61 and the engagement member 62 are disposed at the upstream side of the bypass passage 18w at the valve opening time of the relief valve 19 with respect to the relief valve seat 19b and the discharge valve seat 17b. This makes it possible to prevent the discharge passage of the relief valve 19 from being narrowed. Further, the engagement member 62 can be constituted by the projections radially extending from the discharge valve body 17a, while the stoppage member 61 can be constituted by the projections projecting into the discharge passage 11b from the pump body 11 (including a valve seat forming member 11j secured to the pump body 11) forming the relief valve seat 19b. The above construction can prevent the size of the apparatus from being enlarged as compared with the construction with no stoppage member 61 provided.

Further, the relief valve body 19a has an annular seat surface 17s to be contacted with the discharge valve body 17a at a position radially inward of and flush with the valve seal surface 19d, viz., at the central portion displaced integrally with the valve seal surface 19d, so that the valve seal surface 19d and the seat surface 17s can be concurrently and easily worked, thereby making it possible to reduce the production cost for the fluid control apparatus.

As has been explained in the above description, the fuel supply system provided with the fluid control apparatus according to the present embodiment is provided with the displacement limiting mechanism 60 that limits the displacement of the discharge valve body 17a in the first valve opening direction with respect to the discharge valve seat 17b integrally displaced with the relief valve body 19a, so that the discharge valve body 17a can be separated from the discharge valve seat 17b at the valve opening time of the relief valve 19 when the relief valve body 19a is separated from the relief valve seat 19b. Therefore, not only the bypass passage 18w but also the discharge valve bore 17h can be opened in response to the displacement of the relief valve body 19a at the valve opening time of the relief valve 19. As a consequence of the openings of the bypass passage 18w and the discharge valve bore 17h, a surplus amount of fuel to be relieved by the opening of the relief valve 19 can rapidly be discharged through both of the bypass passage 18w and the discharge valve bore 17h even if the pressure receiving area is decreased to a relatively small value, and the urging force of the valve spring 19c is also decreased to a relatively small value at the valve closing time of the relief valve body 19a. The present embodiment thus constructed can provide not only a fluid control apparatus which is compact in construction and of a high performance, but also a fuel supply system having a high efficiency and an excellent reliability which can satisfy both the enhancement of efficiency of the pressure pump mechanism 20 and the acquirement of the relief flow amount of the fuel.

### Second Embodiment

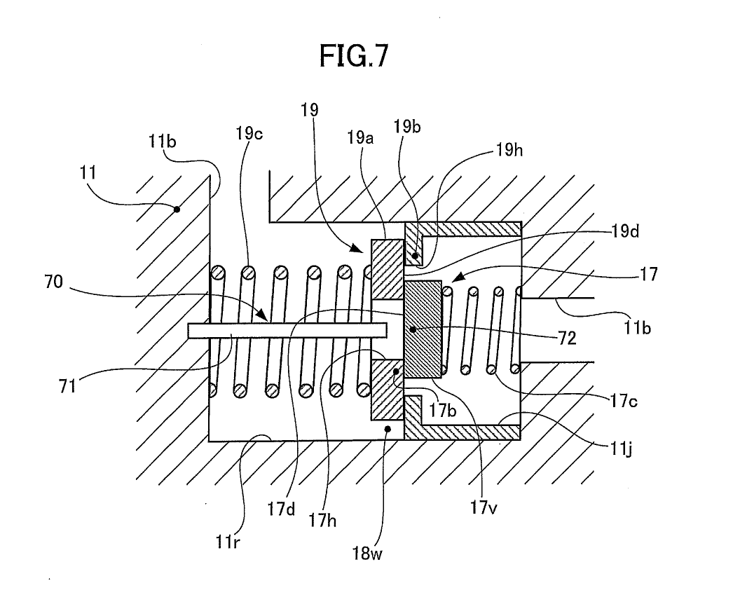

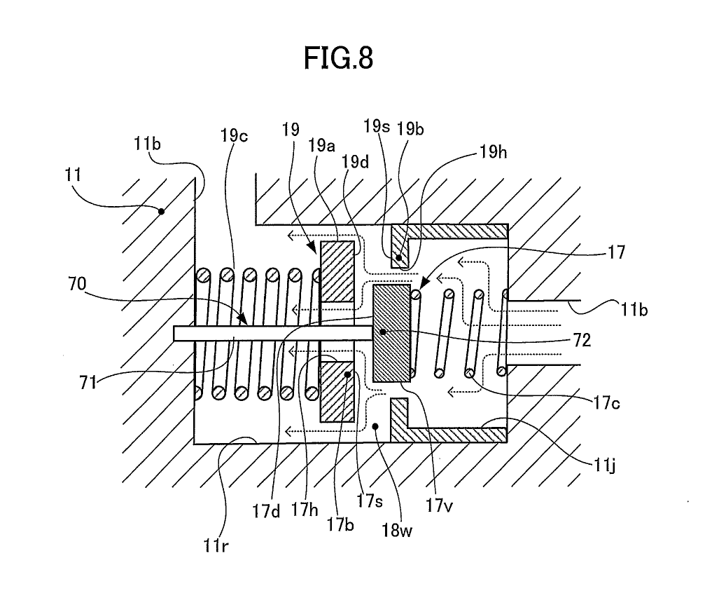

FIG. 7 shows a schematic construction of a fluid control apparatus according to a second embodiment of the present invention, and FIG. 8 shows an operation state at the valve opening time of a relief valve forming part of the fluid control apparatus.

The second embodiment to be explained hereinafter is different from the first embodiment in the aspect of the detailed construction of the fluid control apparatus except for the other constructions which are the same as or similar to those of the first embodiment. Therefore, the constitutional elements or parts forming the second embodiment which are the same as or similar to the constitutional elements or parts forming the first embodiment will be explained hereinafter using the same reference numerals of the elements or parts in the first embodiment as shown in FIGS. 1 to 5.

As shown in FIG. 7 and FIG. 8, the fluid control apparatus according to the second embodiment is provided with a displacement limiting mechanism 70. The displacement limiting mechanism 70 is adapted to limit the displacement of the discharge valve body 17v in the first valve opening direction (leftward direction in FIG. 7) within a preliminarily set movement range with respect to the closed position (position shown in FIG. 7) of the discharge valve body 17v of the discharge valve 17 (second pressure control valve) when the relief valve 19 (first pressure control valve) is closed. In the present embodiment, the discharge valve 17 is constituted by a valve body 17v, a valve seat 17b and a valve spring 17c. The valve body 17v is in the form of a disc shape by removing the plurality of the engagement members 62 from the rear side of the discharge valve body 17a in the first embodiment. The other valve body function portions such as the valve seal surface 17d and the like are similar to those of the discharge valve body 17a.

The displacement limiting mechanism 70 is constituted to include a rod-shaped stoppage member 71 provided on the pump body 11 to be integrally formed with the relief valve seat 19b and to limit the displacement of the valve body 17v in the first valve opening direction, and an engagement member 72 constituted by the central portion of the valve body 17v to be engaged with the stoppage member 71 to limit the displacement of the valve body 17v in the first valve opening direction when the valve body 17v is displaced by a predetermined amount of displacement in the first valve opening direction from the valve closed position (position of the discharge valve body shown in FIG. 7) of the valve body 17v under the valve closed state of the relief valve 19.

Further, the present embodiment is constructed to have the stoppage member 71 and the engagement member 72 disposed at the upstream side (downstream side in the discharge direction through the discharge valve 17) of the bypass passage 18w at the valve opening time of the relief valve 19 with respect to the relief valve seat 19b and the discharge valve seat 17b in the expanded passage portion 11r of the discharge passage 11b which is connected with the bypass passage 18w and the discharge valve bore 17h.

Similarly, the fluid control apparatus according to the present embodiment is provided with a displacement limiting mechanism 70 for limiting the displacement of the discharge valve body 17v in the first valve opening direction with respect to the discharge valve seat 17b integrally displaced with the relief valve body 19a, so that the discharge valve body 17v can be separated from the discharge valve seat 17b at the valve opening time of the relief valve 19 when the relief valve body 19a is separated from the relief valve seat 19b. Therefore, not only the bypass passage 18w but also the discharge valve bore 17h can be opened in response to the displacement of the relief valve body 19a at the valve opening time of the relief valve 19. As a consequence, the second embodiment can obtain an advantageous effect similar to the above stated first embodiment.

The second embodiment is constructed to have the rod-shaped stoppage member 71 disposed in the bypass passage 18w, so that the part of the discharge valve body 17v can function as the engagement member 72, thereby making it possible to simplify the shapes of the parts and to reduce the number of the parts constituting the fluid control apparatus.

### Third Embodiment

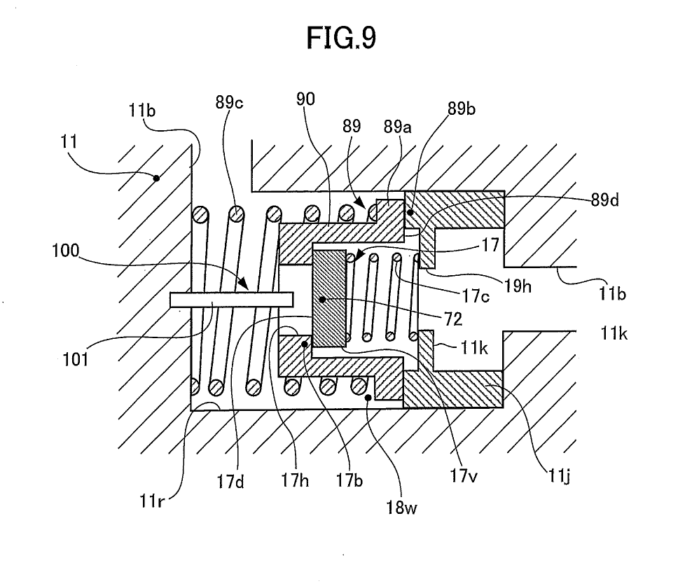

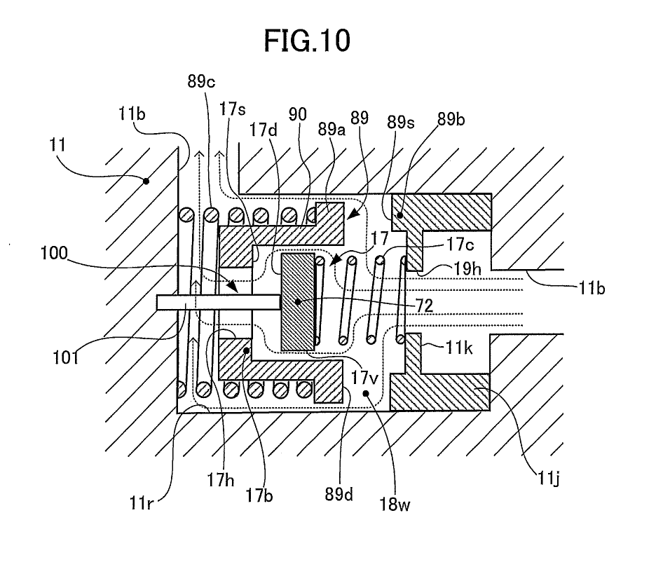

FIG. 9 and FIG. 10 show a schematic construction of a fluid control apparatus according to a third embodiment of the present invention, and an operation state at the valve opening time of a relief valve forming part of the fluid control apparatus.

The following embodiments to be explained hereinafter are different from the previously mentioned embodiments in the aspect of the detailed construction of the fluid control apparatus except for the other constructions which are the same as or similar to those of the previously mentioned embodiments. Therefore, the constitutional elements or parts forming the third embodiment which are the same as or similar to the constitutional elements or parts forming the previously mentioned embodiments will be explained hereinafter using the same reference numerals of the elements or parts in previously mentioned embodiments as shown in FIGS. 1 to 8.

As shown in FIG. 9 and FIG. 10, the fluid control apparatus according to the present embodiment comprises a relief valve 89 (first pressure control valve) having a valve body 89a having a valve seal surface 89d (first seal surface) to be contacted with a valve seat 89b at the valve closing time. The valve body 89a is integrally formed with a bottomed cylindrical member 90 (cylindrical body) which is positioned to be displaced in the first valve opening direction (leftward direction in FIG. 9) from the valve seal surface 89d, and has at the radially inward side of the valve seal surface 89d an annular seat surface 17s (second seat surface) to be contacted with the valve body 17v of the discharge valve 17 (second control valve). The valve body 17v of the discharge valve 17 is accommodated in the bottomed cylindrical member 90 to be displaceable with respect to the bottomed cylindrical member 90.

In the present embodiment, the relief valve 89 is constituted by a plate-shaped valve body 89a (first valve body), an annular valve seat 89b which the valve body 89a is selectively engageable with or separable from, and a valve spring 89c constituted by a compression coil spring that urges the valve body 89a in the valve closing direction to be engaged with the valve seat 89b. The valve body 89a of the relief valve 89 is integrally formed with the bottomed cylindrical member 90, and thus in a roughly cup shape as shown in FIGS. 9 and 10. The discharge valve 17 is constituted by a valve body 17v, a valve seat 17b, and a valve spring 17c, similarly to the second embodiment. The discharge valve 17 has on a flat plate positioned to be displaced in the first valve opening direction from the valve seal surface 89d of the relief valve 89, viz., at the inner bottom wall surface portion of the cylindrical member 90 positioned at the radially inward side of the valve seal surface 89d an annular seat surface 17s to be contacted with the valve seal surface 17d of the discharge valve body 17v.

The pump body 11 has a cylindrical valve seat forming member 11j at the downstream side of the expanded passage portion 11r of the discharge passage 11b. The valve seat forming member 11j has one end side at which the valve seat 89b of the relief valve 89 is formed. In the vicinity of the valve seat 89b of the valve seat forming member 11j is formed a spring receiving portion 11k which supports the base end side of the valve spring 17c of the discharge valve 17.

Further, the fluid control apparatus according to the present embodiment is provided with a displacement limiting mechanism 100 that limits the displacement of the discharge valve body 17v in the first valve opening direction (leftward direction in FIG. 9) within a preliminarily set movement range with respect to the closed position (position shown in FIG. 9) of the discharge valve body 17v of the discharge valve 17 when the relief valve 89 is closed.

The displacement limiting mechanism 100 is constituted to include a rod-shaped stoppage member 101 provided on the pump body 11 to be integrally formed with the relief valve seat 89b and to limit the displacement of the valve body 17v in the first valve opening direction, and an engagement member 72 constituted by the central portion of the valve body 17v to be engaged with the stoppage member 101 to limit the displacement of the valve body 17v in the first valve opening direction when the valve body 17v is displaced by a predetermined amount of displacement in the first valve opening direction from the valve closed position of the valve body 17v under the valve closed state of the relief valve 89.

Further, the present embodiment is constructed to have the stoppage member 101 and the engagement member 72 disposed at the downstream side (upstream side in the discharge direction through the discharge valve 17) of the bypass passage 18w at the valve opening time of the relief valve 89 with respect to the relief valve seat 89b and the discharge valve seat 17b in the expanded passage portion 11r of the discharge passage 11b which is connected with the bypass passage 18w and the discharge valve bore 17h.

The fluid control apparatus according to the present embodiment is also provided with a displacement limiting mechanism 100 for limiting the displacement of the discharge valve body 17v in the first valve opening direction with respect to the discharge valve seat 17b integrally displaced with the relief valve body 89a, so that the discharge valve body 17v can be separated from the discharge valve seat 17b at the valve opening time of the relief valve 89 when the relief valve body 89a is separated from the relief valve seat 89b. Therefore, not only the bypass passage 18w but also the discharge valve bore 17h can be opened in response to the displacement of the relief valve body 89a at the valve opening time of the relief valve 89. As a consequence, the present embodiment can obtain an advantageous effect similar to the above stated embodiments.

Moreover, the present embodiment is provided with the cylindrical member 90 integrally formed with the relief valve body 89a, so that the cylindrical member 90 makes it possible to form a fluid passage having a sufficiently large cross-section area at the position radially inward of the cylindrical member 90 and opposite to the discharge valve seat 17b with respect to the discharge valve body 17v. This makes it possible to secure the sufficiently large cross-sectional area of the bypass passage 18w to discharge the surplus fuel at the valve opening time of the relief valve 89, and thus to enhance the relief performance of the relief valve 89.

### Fourth Embodiment

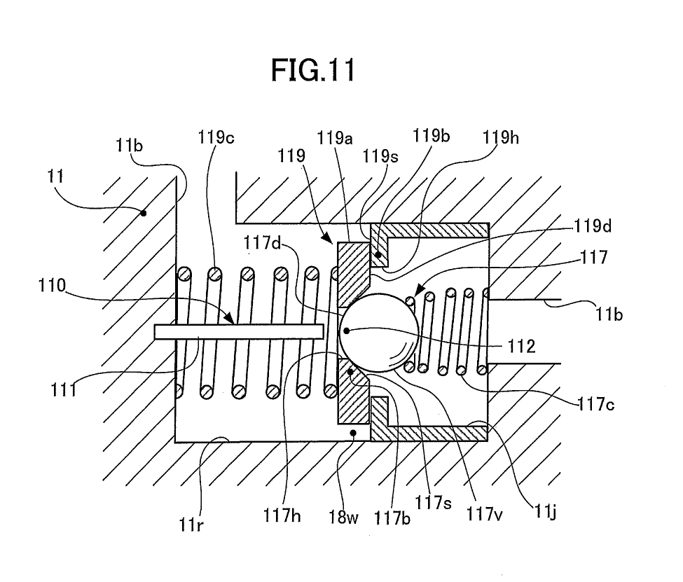

FIG. 11 shows a schematic construction of a fluid control apparatus according to a fourth embodiment of the present invention.

As shown in FIG. 11, the fluid control apparatus according to the present embodiment comprises a relief valve 119 (first pressure control valve) having a valve body 119a having a valve seal surface 119d (first seal surface) to be contacted with a valve seat 119b at the valve closing time. The valve body 119a of the relief valve 119 has a roughly conical seat surface 117s (second seat surface) positioned to be displaced in the first valve opening direction (leftward direction in FIG. 11) from the valve seal surface 119d, viz., positioned radially inwardly of the valve seal surface 119d to be contacted with a spherical valve body 117v of a discharge valve 117 (second control valve). The valve body 117v of the discharge valve 117 is accommodated in the central portion of the valve body 119a forming the seat surface 117s to be displaceable with respect to the valve body 119a.

In the present embodiment, the discharge valve 117 functions as a check valve having a spherical valve body 117v. The discharge valve 117 is constituted by a spherical valve body 117v (second valve body) capable of opening or closing the discharge passage 11b in the valve closing state of the relief valve 119, a tapered valve seat 117b (second valve seat) which the valve body 117v is selectively engageable with or separable from, and a compression coil spring 117c (second valve spring) that urges the valve body 117v in the valve closing direction to be seated on the valve seat 117b.

Further, the relief valve 119 is constituted by a plate-shaped valve body 119a (first valve body), an annular valve seat 119b which the valve body 119a is selectively engageable with or separable from similarly to the first embodiment, and a valve spring 119c constituted by a compression coil spring that urges the valve body 119a in the valve closing direction to be engaged with the valve seat 119b.

Further, the fluid control apparatus according to the present embodiment is provided with a displacement limiting mechanism 110 for limiting the displacement of the discharge valve body 117v in the first valve opening direction (leftward direction in FIG. 11) within a preliminarily set movement range with respect to the closed position (position shown in FIG. 11) of the discharge valve body 117v of the discharge valve 117 when the relief valve 119 is closed.

The displacement limiting mechanism 110 is constituted to include a rod-shaped stoppage member 111 provided on the pump body 11 to be integrally formed with the relief valve seat 119b and to limit the displacement of the valve body 117v in the first valve opening direction, and an engagement member 112 constituted by part of the valve body 117v to be engaged with the stoppage member 111 to limit the displacement of the valve body 117v in the first valve opening direction when the valve body 117v is displaced by a predetermined amount of displacement in the first valve opening direction from the valve closed position of the valve body 117v under the valve closed state of the relief valve 119.

Further, the present embodiment is constructed to have the stoppage member 111 and the engagement member 112 disposed at the downstream side (upstream side in the discharge direction through the discharge valve 117) of the bypass passage 18w at the valve opening time of the relief valve 119 with respect to the relief valve seat 119b and the discharge valve seat 117b in the expanded passage portion 11r of the discharge passage 11b which is connected with the bypass passage 18w and the discharge valve bore 117h.

Similarly, the fluid control apparatus according to the present embodiment is provided with the displacement limiting mechanism 110 that limits the displacement of the discharge valve body 117v in the first valve opening direction with respect to the discharge valve seat 117b to be displaced integrally with the relief valve body 119a, so that the discharge valve body 117v can be separated from the discharge valve seat 117b at the valve opening time of the relief valve 119 to have valve body 119a separated from the valve seat 119b. Therefore, not only the bypass passage 18w but also the discharge valve bore 117h can be opened in response to the displacement of the relief valve body 119a at the valve opening time of the relief valve 119. As a consequence, the present embodiment can obtain an advantageous effect similar to the above stated embodiments.

In the present embodiment, the discharge valve 117 integrally displaced with the relief valve 119a is constituted by a check valve having a spherical valve body 117v, thereby making it possible to obtain a favorable seal performance at the valve closing time of the discharge valve 117.

### Fifth Embodiment

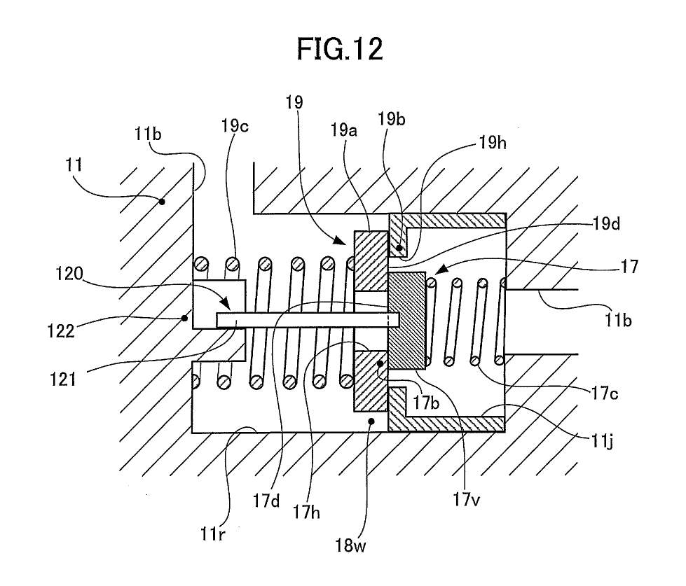

FIG. 12 shows a schematic construction of a fluid control apparatus according to a fifth embodiment of the present invention.

As shown in FIG. 12, the fluid control apparatus according to the present embodiment comprises a relief valve 19 (first pressure control valve) having a valve body 19a having a valve seal surface 19d (first seal surface) to be contacted with a valve seat 19b at the valve closing time. The valve body 19a of the relief valve 19 has an annular seat surface 17s (second seat surface) to be contacted with the discharge valve body 17v of the discharge valve 17 (second pressure control valve) positioned radially inwardly of the valve seal surface 19d and flush with the valve seal surface 19d of the relief valve 19. This means that the discharge valve 17 is constituted by a valve body 17v, a valve seat 17b, and a valve spring 17c, while the discharge valve 19 is constituted by a valve body 19a, a valve seat 19b, and a valve spring 19c.

Further, the fluid control apparatus according to the present embodiment is provided with a displacement limiting mechanism 120 for limiting the displacement of the discharge valve body 17v in the first valve opening direction (leftward direction in FIG. 12) with respect to the valve closed position (position shown in FIG. 12) of the discharge valve body 17v when the relief valve 19 is closed.

The displacement limiting mechanism 120 is constituted to include a rod-shaped stoppage member 121 integrally formed with the valve body 17v, and an engagement member 122 formed by part of the discharge passage inner wall portion of the pump body 11. The stoppage member 121 can limit the displacement of the valve body 17v in the first valve direction by the pump body 11 when the valve body 17v is displaced in the first valve direction to be brought into engagement with the pump body 11. The engagement member 122 is adapted to be engaged with the stoppage member 121 to limit the displacement of the valve body 17v in the first valve direction when the valve body 17v is displaced by a predetermined displacement amount in the first valve opening direction from the valve closed position of the valve body 17v under the valve closed position of the relief valve 19.

Further, the present embodiment is constructed to have the stoppage member 121 and the engagement member 122 disposed at the downstream side (upstream side in the discharge direction through the discharge valve 17) of the bypass passage 18w at the valve opening time of the relief valve 19 with respect to the relief valve seat 19b and the discharge valve seat 17b in the expanded passage portion 11r of the discharge passage 11b which is connected with the bypass passage 18w and the discharge valve bore 17h.

Similarly, the fluid control apparatus according to the present embodiment is provided with the displacement limiting mechanism 120 for limiting the displacement of the discharge valve body 17v in the first valve opening direction with respect to the discharge valve seat 17b to be displaced integrally with the relief valve body 19a, so that the discharge valve body 17v can be separated from the discharge valve seat 17b at the valve opening time of the relief valve 19 to have valve body 19a separated from the valve seat 19b. Therefore, at the valve opening time of the relief valve 19, not only the bypass passage 18w can be opened, but also the discharge valve bore 17h can be opened in response to the displacement of the relief valve 19a. As a result, the present embodiment can obtain an advantageous effect similar to the above stated embodiments.

The above embodiments have been explained about the case in which a member displaced integrally with the relief valve body (first valve body) is constituted by a relief member itself or a member integrally formed with the relief member, however, the connection structure for integrally displacing the relief valve body and the discharge valve seat (first valve body and the second valve seat) is not necessarily limited to one part connected integrally but may include more than one part, i.e., a plurality of parts connected with each other. The engagement member may be constituted by a rod-shaped member projecting toward the rear side of the discharge valve body, and an engagement portion such as for example a hook-shaped engagement portion, a plate-shaped engagement portion, a bore inner wall shaped engagement portion, and a step shaped engagement portion to be engaged with a stoppage member of the pump body 11 at the rear end portion of the rod-shaped member. The stoppage member and the engagement member in the present invention is not limited to the rod-shaped stoppage member and the flange-shaped engagement member, but may be formed to take any shape if the stoppage member and the engagement member are engageable with each other and displaceable in the first valve opening direction of the second valve body. Further, each of the above embodiments is constructed to use each of the first and second pressure control valves achieving a pressure adjustment function by the valve spring, respectively, as a check valve, however, each of the first and second pressure control valves is not necessarily constituted by such a check valve, but may be constituted by other pressure control valve such as for example a pressure adjustment valve, a pressure reduction valve, a safety valve or the like. Each of the first and second pressure control valves may be replaced by a fluid control valve which can variably control the flow rate and the flow direction other than the pressure control of the fluid if the control valve has a function of the pressure control valve. The valve spring is of course not limited to the compression coil spring, but may be replaced by any type of a resilient member. The fluid control apparatus according to the present invention is not limited to an apparatus for controlling the flow of fuel, but may of course control other fluid as a control target.

From the foregoing description, it will be understood that the fluid control apparatus according to the present invention and the fuel supply system provided with the above fluid control apparatus are provided with a displacement limiting mechanism for limiting the displacement of the second valve body in the first valve opening direction with respect to the second valve seat integrally displaced with the first valve body, thereby making it possible to separate the second valve body from the second valve seat when the first pressure control valve is opened to have the first valve body separated from the first valve seat. Therefore, at the valve opening time of the first pressure control valve, not only the first fluid passage but also the second fluid passage can be opened in response with the displacement of the first valve body. Even if the pressure receiving area of the first valve body at the valve opening time of the first valve body is relatively decreased, and the urging force of the first valve spring is also decreased, the fuel relieved by the valve opening of the first pressure control valve can rapidly be discharged through both of the first and second fluid passages. Therefore, the present invention can provide a fluid control apparatus which is compact in construction and has a high performance, and also can provide a fuel supply system which can obtain both of the merits of improving the efficiency of the pressure pump mechanism and of securing a required relief flow amount, thereby making it possible for the fuel supply system to secure a high efficiency and an excellent reliability. The present invention is generally useful for the fluid control apparatus having a plurality of valve elements, and the fuel supply system provided with the above fluid control apparatus.

### REFERENCE SIGNS LIST

1: fuel supply system

2: engine (internal combustion engine)

5: low pressure fuel pump (feed pump)

6: injector (fuel injection valve)

7: delivery pipe

10: fuel supply apparatus

11: pump body

11a: suction passage (suction side fluid passage)

11b: discharge passage (discharge side fluid passage)

11r: expanded passage portion (fluid passage connected in parallel with first and second fluid passages)

12: plunger (pressure member)

13: suction gallery (fuel storing chamber)

15: fuel pressure chamber

17; 117: discharge valve (second pressure control valve, fluid control valve)

17a; 117a: valve body (discharge valve body, second valve body)

17b; 117b: valve seat (discharge valve seat, second valve seat)

17c, 19c: valve spring

17d: valve seal surface (second seal surface)

17h; 117h: valve bore (discharge valve bore, second fluid passage)

17s; 117s: seat surface (second seat surface) 17v; 117v: valve body (discharge valve body, second fluid passage)

18w: bypass passage (first fluid passage)

19; 89; 119: relief valve (first pressure control valve, fluid control valve)

19a; 89a; 119a: valve body (relief valve body, first valve body)

19b; 89b; 119b: valve seat (relief valve seat, second valve seat)

19d; 89d; 119d: valve seal surface (first seal surface)

19h: valve bore (first fluid passage)

20: pressure pump mechanism

29: auxiliary chamber (internal chamber)

29a: inner communication passage (internal chamber)

60; 70; 100; 110; 120: displacement limiting mechanism

61; 71: stoppage member

62; 72: engagement member

90: cylindrical member (member displacing integrally with first valve)

101; 111; 121: stoppage member

112; 122: engagement member

1. A fluid control apparatus, comprising:
first and second pressure control valves respectively having first and second valve seats respectively forming parts of first and second fluid passages connected in parallel with each other, first and second valve bodies respectively engageable with the first and second valve seats to close the first and second fluid passages, and first and second valve springs for respectively urging the first and second valve bodies in the respective valve closing directions,
the fluid control apparatus being operative to have the first valve body moved in a first valve opening direction in which the first valve body is separated from the first valve seat under a first valve opening drive pressure, and to have the second valve body moved in a second opening direction in which the second valve body is separated from the second valve seat under a second valve opening drive pressure, the first and second opening directions being opposite to each other, and the first and second valve opening drive pressures being different from each other,
the second valve seat being formed with a member integrally displaced with the first valve body,
the fluid control apparatus further comprising a displacement limiting mechanism provided to limit the displacement of the second valve body in the first valve opening direction with respect to the closed position of the second valve body when the first pressure control valve is closed.

2. The fluid control apparatus as set forth in claim 1, in which the second valve seat is integrally provided with the first valve body.

3. The fluid control apparatus as set forth in claim 1, in which the displacement limiting mechanism is constituted to include a stoppage member integrally provided with any one of the first valve seat and the second valve body to limit the displacement of the second valve body in the first valve opening direction, and an engagement member to be engaged with the stoppage member to regulate the displacement of the second valve body in the first valve opening direction when the second valve body is displaced by a predetermined amount of displacement in the first valve opening direction from the closed valve position of the second valve body.

4. The fluid control apparatus as set forth in claim 3, in which the stoppage member and the engagement member are disposed at the upstream side of the first fluid passage in the valve open state of the first pressure control valve with respect to the first and second valve seats in a fluid passage having the first and second fluid passages connected in parallel with each other.

5. The fluid control apparatus as set forth in claim 3, in which the stoppage member and the engagement member are disposed at the downstream side of the first fluid passage in the valve open state of the first pressure control valve with respect to the first and second valve seats in a fluid passage having the first and second fluid passages connected in parallel with each other.

6. The fluid control apparatus as set forth in claim 1, in which the first valve body has a first seal surface to be contacted with the first valve seat at the valve closing time of the first valve body, the first valve body being displaceable integrally with a member having an annular second seal surface flush with the first seal surface and the radially inward of the first seal surface to be contacted with the second valve body.

7. The fluid control apparatus as set forth in claim 1, in which the first valve body has a first seal surface to be contacted with the first valve seat at the valve closing time of the first valve body, the first valve body being displaceable integrally with a member constituted by a cylindrical body having an annular second seal surface positioned to be displaced from the first seal surface in the first valve opening direction and the radially inward of the first seal surface to be contacted with the second valve body, the second valve body being accommodated in the member displaceable integrally with the first valve body.

8. A fuel supply system provided with the fluid control apparatus as set forth in claim 1, comprising:
a pump body formed with a fuel introduction port and a fuel discharge port, and formed with a low pressure side fuel passage held in communication with the fuel introduction passage and a high pressure side fuel passage held in communication with the fuel discharge port,
a pressure pump mechanism having a fuel pressure chamber formed between the low pressure side fuel passage and the high pressure side fuel passage in the pump body, and a pressuring member driven to pressurize the fuel in the fuel pressure chamber,
a plurality of valve elements including a suction valve opened to allow the fuel to be sucked into the fuel pressure chamber from the low pressure side fuel passage, and a discharge valve opened to allow the fuel to be discharged to the high pressure side fuel passage from the fuel pressure chamber, and
the second pressure control valve constituting the discharge valve, and the first pressure control valve constituting the relief valve having a valve opening direction opposite to that of the discharge valve, and an opening set pressure larger than that of the discharge valve.
